(19) United States
(12) Patent Application Publication
(10) Pub. No.: US 2003/0200078 A1
(43) Pub. Date: Oct. 23, 2003

(54) System and method for language translation of character strings occurring in captured image data

(76) Inventors: Huitao Luo, Redwood City, CA (US); Jian Fan, Cupertino, CA (US); Jonathan Yen, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/126,152

(22) Filed: Apr. 19, 2002

(51) Int. Cl. G06F 17/28

(52) U.S. Cl. 704/2

(57) ABSTRACT

A system and method capable of performing language translation of a graphical representation of a first language character string within captured image data of a natural image by extracting image data corresponding to the graphical representation of the text from the captured image data. The extracted graphical representation is then converted into first language encoded character data that, in turn, is translated into a second language data. The translated text and the captured image can then be displayed together by overlaying the translated text over the graphical representation of the character string in the captured image.

### FIELD OF THE INVENTION

The present invention relates to a system and method of language translation, and in particular this disclosure provides a system and method for translating character strings found in captured image data from one language to another.

### BACKGROUND OF THE INVENTION

Electronic dictionaries are often used as language translators when people travel to foreign countries. Most electronic dictionaries currently on the market are embodied as hand held devices having a keyboard and a display that allow the user to type in words, phrases, or sentences (herein referred to as a character string) of one language. FIG. 1A shows a system block diagram of a typical electronic dictionary including a keyboard 10, translation software 11, and a display 12. A character string is typed in and then translated by the translation software 11 (typically embedded within the device) and a corresponding translated character string is displayed to the user. In general, the software 11 identifies syntax and common phrases within the string and employs a keyword-based database to perform the translation. The devices are hand held so as to make it convenient for a tourist to use when in another country or for a student to use when studying a language.

There are several problems with these types of translators. First, since they are hand held devices they have an inherently limited amount of computing power. Consequently, the translation software may be slow and is often unsophisticated such that translation errors may occur. In addition, these types of translator devices are not suited for pictograph character languages having thousands of characters (such as Chinese, Japanese, and Korean) since the keyboard size required to accommodate such a language would be unmanageably large for a portable device. In one known technique, the number of necessary keys can be reduced by, for example, using coding by visual inspections. As a result, less keys than characters would be required. However, this technique generally requires familiarity of the language being translated as well as the coding method.

Another known translation system (FIG. 1B) used for translating text on a document from one language to another includes a laptop computer having a scanner (13) equipped with optical character recognition (OCR) software (14) and translation software (15). A document is scanned into the laptop computer so as to create a digital bit map of the surface of the document. The OCR software converts the digital bit map data corresponding to the text into recognizable character strings and, in particular, encoded character string data corresponding to the original language. Finally, the translation software converts the encoded character string data into translated data corresponding to a new selected language. The translated text can then be displayed by display 16. One of the main drawbacks of this system is that it is limited to translation of only scanned-in documents.

When a person is traveling in a foreign country, there is often a need to translate signs occurring in the natural environment for directions. For instance, in an airport there are typically signs directing individuals to the baggage area, the main terminal, etc. However, since signs obviously cannot be scanned, the only manner available at this time to translate a sign is by using an electronic dictionary. Specifically, the individual characters on the signed would need to be keyed in to obtain a translation of the sign. As described above, this may not be possible dependent on the type of language being translated, may have translation errors, and can be inconvenient for the user if they are in a hurry.

Hence a need exists for a system and method of translating signs posted in a natural environment.

### SUMMARY OF THE INVENTION

A system and method of language translation of a graphical representation of a character string in image data is described. The system includes a character image extractor that extracts character string information corresponding to the graphical representation of the character string from captured image data, for example, an image captured of posted signs at an airport terminal. The extracted character string information is converted into recognizable characters of a first language having the format of first encoded character string data. The converted encoded data is then translated into translated data corresponding to a second language. In one embodiment of the system and method, the translated data is displayed in a display area.

### BRIEF DESCRIPTION OF THE DRAWINGS

FIG. 1A illustrates a first prior art language translation system;

FIG. 1B illustrates a second prior art language translation system;

FIGS. 2A and 2B illustrate two examples of a graphical representation of a character string in a natural environment;

FIG. 3 illustrates a first embodiment of the language translation system of the present invention;

FIG. 4 illustrates a second embodiment of the language translation system of the present invention;

FIGS. 5A and 5B illustrate a user interface displaying translated text in accordance with one embodiment of the present invention;

FIG. 6 illustrates a first embodiment of a method of language translation in accordance with the present invention;

FIG. 7A illustrates a second embodiment of a method of language translation in accordance with the present invention; and

FIG. 7B illustrates an example of a sign including an iconic symbol and a graphical character string.

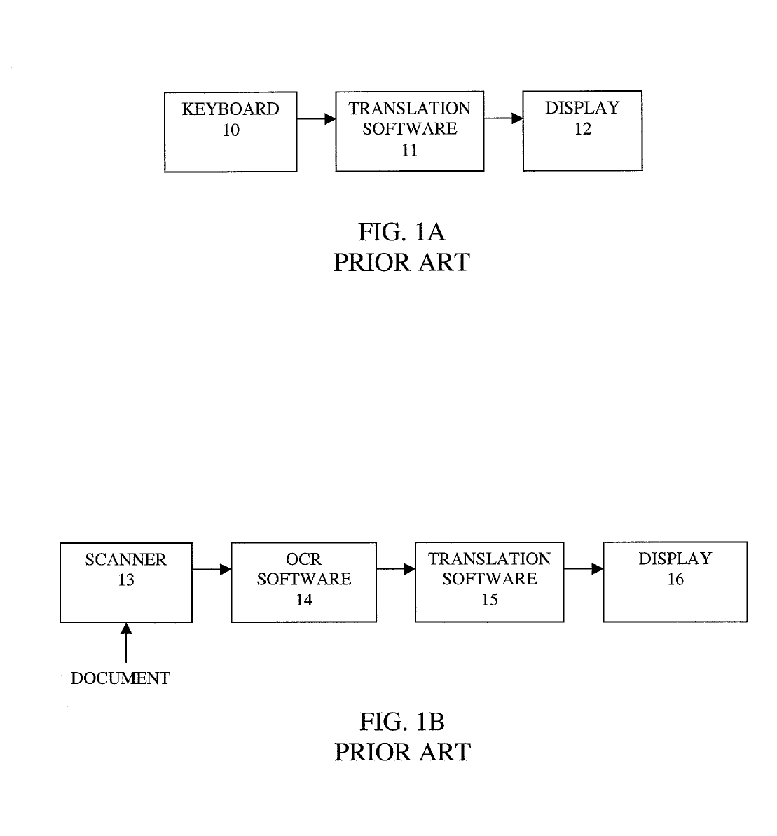

### DETAILED DESCRIPTION OF THE INVENTION

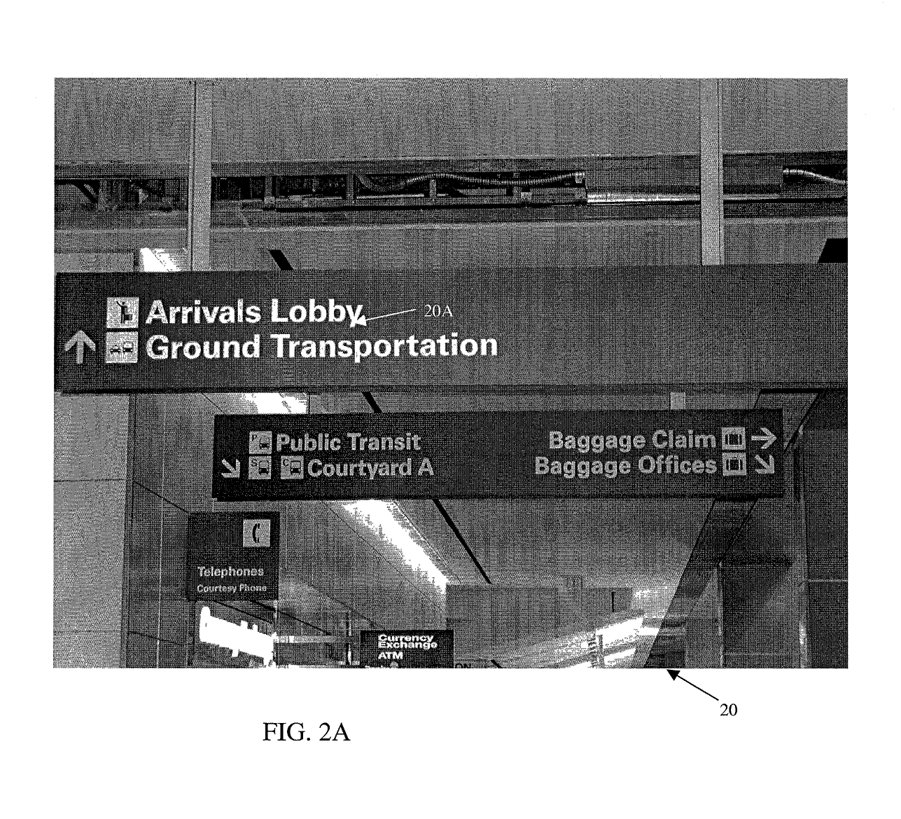

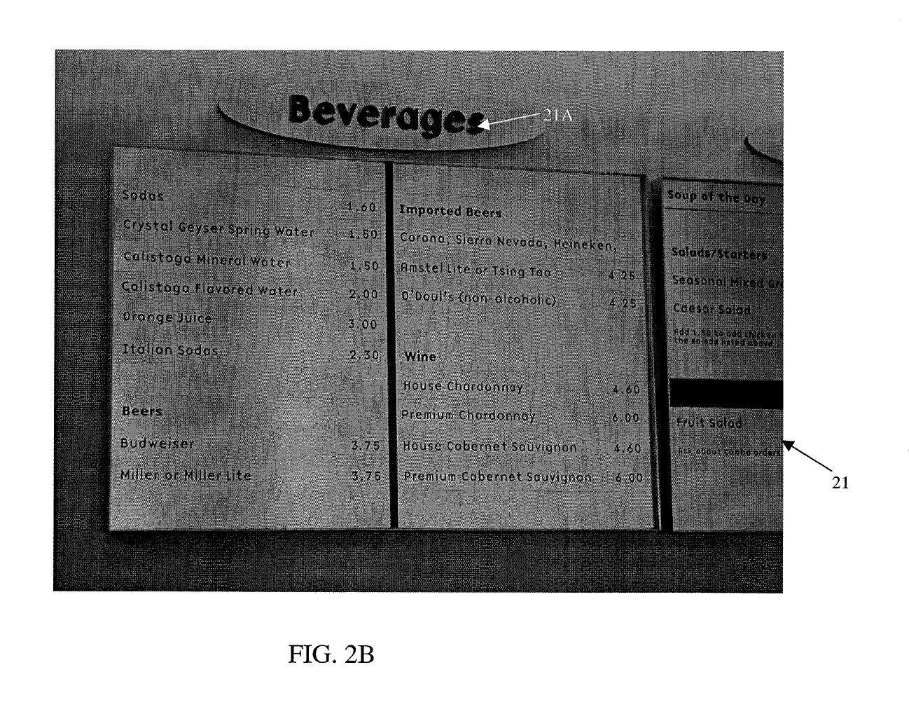

In general, a system and method capable of language translation of signs posted in the natural environment from captured image data of the posted signs is described. It should be noted that captured image data as described in this disclosure includes at least a portion of image data corresponding to a graphical representation of at least one character string. The captured image data can further include image data corresponding to other objects naturally occurring in the environment about the graphical representation of the character string (e.g., inanimate and animate objects). Image data corresponding to signs often include a graphical representation of a single word, phrase, sentence or string of characters in a corresponding language that are bounded by the outside perimeter of the sign. FIGS. 2A and 2B show examples of two images (20) and (21) each including signs having a graphical representation of at least one character string (20A and 21A). In general, a “sign” according to this disclosure can be any informative character strings contained in the natural environment.

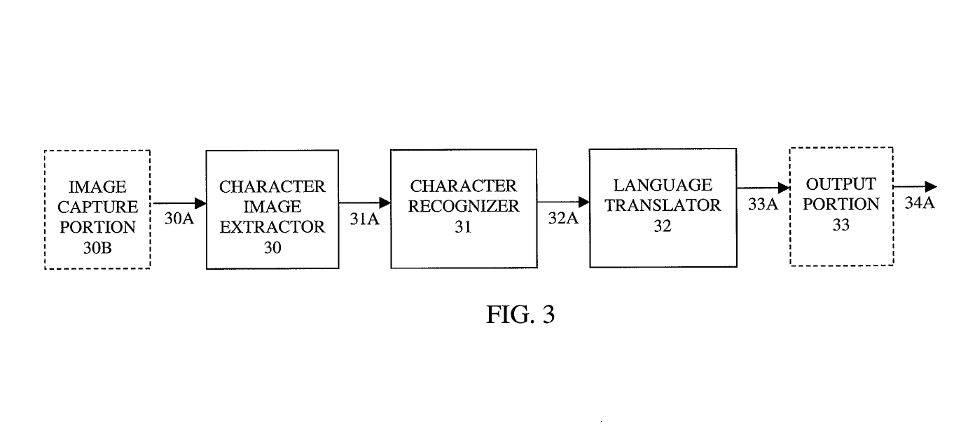

FIG. 3 shows a first embodiment of a language translation system of the present invention including a character image extractor (30), a character recognizer (31), and a language translator (32). Optionally the system further includes image capture portion 30B and output portion 33 (shown in a dashed representation) as will described herein below. Captured image data (30A) including image data corresponding to a graphical representation of at least one character string is coupled to the character image extractor (30). Captured image data (30A) can be embodied as a pixel array of grayscale or RGB values. The character image extractor (30) extracts character string information (31A) from the captured image data (30A). The character string information (31A) describes image data corresponding to the graphical representation of the character string in terms of digitized image characteristics data. In one embodiment, the character string information includes at least the binary bitmap data representing the detected/extracted character string, e.g., using “1” to represent the character pixels and “0” to represent background pixels. In another embodiment, the character string information includes data corresponding to a description of bounding boxes associated with each character and/or string of characters.

In one embodiment, extractor 30 is implemented in accordance with the system and method as described in a co-pending application (Attorney Docket No.: 100201465) incorporated herein by reference. In accordance with this embodiment, the character edges of the graphical representation of the character string in the image data are detected to generate an edge representation of the image data. The edge representation includes a plurality of edges of single-pixel width each having an associated magnitude and direction. Edge pixel labels are assigned dependent on the labeling of adjacent edge pixels. In one embodiment, edge pixel labeling is based on edge pixel connectedness. In another embodiment, edge pixel labeling is based further on edge pixel direction. Character bounding area definitions are created using the edge representation information and dependent on similar edge pixel labels. In one embodiment, character definitions are created by identifying and linking end point edge pixels at high character curvature areas. The character boundary definitions are filtered using direction information to identify character foreground and background information. In one embodiment, definitions are further filtered by analyzing one or both of character bounding area definition geometry and/or grayscale uniformity. Filtered definitions are combined with adjacent boundary definitions to form a line definition dependent on the adjacent bounding area definitions relative location to each other. The character string information is provided to the character recognizer (31).

The character recognizer (31) functions to convert the character string information (e.g., the binary bitmap and bounding boxes of character string) into first encoded data (32A) corresponding to a first language. In general encoded data describes the character string in terms of recognized characters in the string. For instance, the characters of the alphabet of the English language can be represented by the ASCII (American Standard Code Information) code where each letter of the alphabet can be represented by a corresponding standardized digital code word. In one preferred embodiment, UNICODE encoding is the preferred encoding method because it supports most languages, and is becoming a worldwide standard. It should be noted that the first language corresponds to the same language of the original graphical representation of the character string.

The character recognizer converts the character string information into encoded data by recognizing the characters in the character string information and generating a corresponding encoded data word for each recognized character. In one embodiment, the character recognizer is embodied as optical character recognition (OCR) software. OCR software is well known in the field and a detailed description of OCR software is beyond the scope of this disclosure and not necessary for the understanding of the subject invention. However, it should be understood that, in general, OCR software functions to convert bitmap image data corresponding to a document having text into encoded data corresponding to the text by using, for instance, a thresholding technique on the bitmap data. The first encoded data (32A) is coupled to the language translator (32).

The language translator (32) functions to convert the first encoded data into translated data (33A) corresponding to a second language. Language translators are well known in the field and a detailed description of the language translator is beyond the scope of this disclosure and not necessary for the understanding of the subject invention. However, it should be understood that, in general, a language translator functions to convert encoded characters of a first language into coded characters of a second language (i.e., the target language). Once characters are converted, the second language encoded data character strings are compared to a database of keywords and phrases. Often language translators analyze the converted character strings in terms of known syntax rules of a target language to obtain the translation of the character string. The language translator (32) then outputs translated data (33A) corresponding to the character string in the second language.

In another embodiment of the system of language translation shown in FIG. 3 the system further includes an optional image capture portion (30B) for capturing the image data (30A). And in still another embodiment, the system of FIG. 3 further includes an output portion 33 (e.g., a display area, printer, audio microphone) for outputting the translated data. For instance, in accordance with these embodiments, the image capture portion 30B and the output portion 33 can be embodied within a digital camera or a hand held computing device (such as a PDA). Hence, a user can conveniently obtain image data of a posted sign for translation using the image capture portion 30B of the digital camera or hand held device and the translation can be conveniently provided to the user via the output portion 33 (e.g., display area, print out, or audio microphone).

In still another embodiment, the system can be implemented by a stand-alone unit or by a client/server infrastructure model. In a stand-alone implementation, all the processing elements of the system (30B, 30, 31, 32, 33, FIG. 3) are implemented within a mobile device (such as a digital camera or PDA). To minimize size and power usage, the character recognizer 31 and the language translator 32 can be customized in such a way that only the necessary translation and recognition elements are implemented within the mobile device. For example, if a system user is preparing a trip to Germany from United States, then only German character recognizer (OCR) functions are needed for recognizer 31, and only German-English translation functions are needed for translator 32. Moreover, in the case in which the character recognizer 31 and the language translator 32 are implemented as software algorithms, then only those functional portions of the algorithms corresponding to German recognition functions and German-English translation functions are installed within the mobile device.

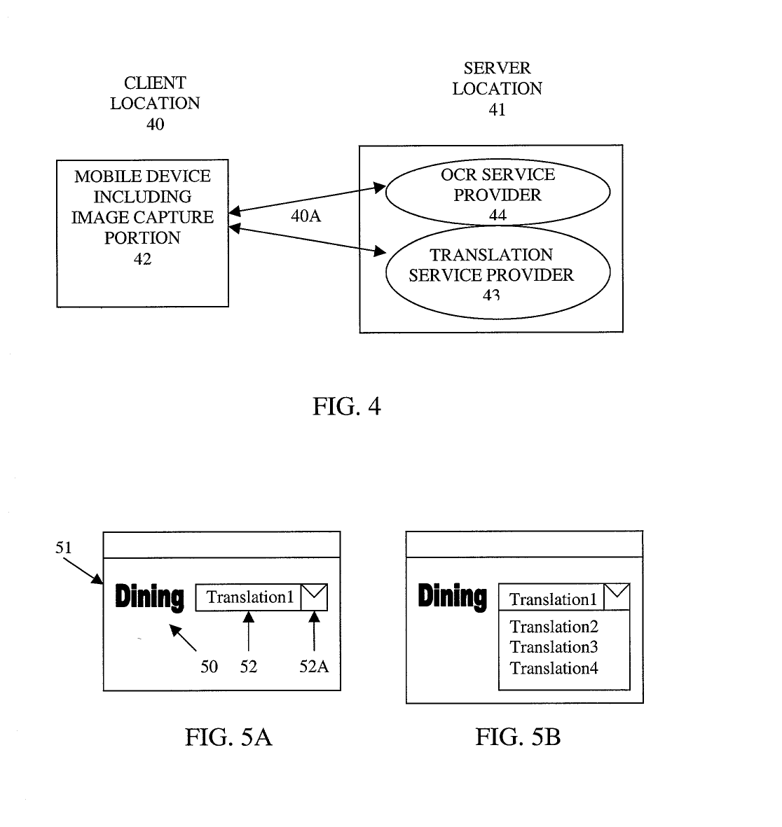

FIG. 4 illustrates an embodiment of the present invention in which the system is implemented by a client/server infrastructure model. In this embodiment, a first portion of the elements of the system are implemented at a client location 40 and a second portion of the elements are implemented at a server location 41. As shown, a mobile device 42 including an image capture portion (e.g., a digital camera, a PDA) resides at the client location 40 and is in communication via communication path 40A with the server location 41. The server location includes an OCR server provider 43 and a translation service provider 44. Communication between the client and server locations can be either through a wired connection or wireless connection. The character image extractor 30 (FIG. 3) can be located either at the client location 40 or at the server location 41.

In the case in which the character image extractor 30 resides at the client location 40, the mobile device 42 captures the image data 30A (FIG. 3) and the image data 31A corresponding to the graphical representation of the character string is extracted by extractor 30 and transmitted to the server location 41. At the server location, the OCR service provider 43 performs character recognition on data 31A and generates encoded data 32A. The encoded data 32A can then be translated by the translation service provider 44. This embodiment of the system of language translation of the present invention facilitates an architecture in which minimal processing (image data extraction) is performed by the inherently low power mobile device 42 at the client location 40 and more complex processing (OCR and translation) is performed at the server location 41. It should be noted that the OCR service provider and the translation service provider need not be at the same server location. Instead, it should be understood that these providers are provided by a source remote to the client location.

In the case in which the character image extractor resides at the server location 41, the mobile device 42 functions to capture an image including the image data corresponding to the graphical representation of at least one character string and transmit the captured image data to server location 41. At least one service can then perform image data extraction, character recognition, and language translation according the system shown in FIG. 3. Translated information can then be transmitted from the server location 41 back to the client location 40 for outputting by the mobile device.

It should be understood that the character image extractor 30, character recognizer 31, and language translator 32 can be implemented as software, hardware, or any combination of software and hardware.

In accordance with another embodiment of the subject invention, the output portion 33 is implemented as a display area and the translated data 33A is displayed by a graphical user interface. In one embodiment of the graphical user interface, the entire captured image data 30A is displayed in the display area within a window of the interface that includes the graphical representation of pre-translated character strings. After translation is performed, the translated data 33A is displayed on top of the displayed captured image data 30A either adjacent to or on top of the image of the original corresponding pre-translated character string.

In another embodiment, a menu appears adjacent to or on top of the pre-translated character string in the captured image, and by selecting the menu, a list of possible translations is displayed. As shown in FIG. 5A a graphical representation of a character string 50 is displayed within a user interface window 51. A menu window 52 is shown adjacent to the character string 50 displaying the most likely translation of the character string (Translation1). If the translation does not appear correct, the user can activate the menu by selecting activation area 52A (via a user interface device), and a list of translations, Translation2-Translation4, can be displayed (FIG. 5B).

In one embodiment of the present invention, the entire captured image data is displayed in the display area and the user can select using the interface to simultaneously translate all character strings within the captured image data. Once translated, the translated text for all character strings is displayed on top of or adjacent to each corresponding string. In an alternative embodiment, the interface can be used to navigate through the displayed image corresponding to the capture image data and to select a single graphical character string (e.g., a single posted sign) within the displayed image for translation. In this case, only the selected string is translated and the corresponding translation is displayed. Selecting and translating a single character string minimizes the amount of data processing and hence, the translation time. In still another embodiment, the image capture portion (FIG. 3) can include a “zoom” function that allows a user to “zoom” into a particular posted sign such that the image captured is primarily of the posted sign. As a result, the captured image data primarily includes image data corresponding to the graphical representation of a single character string making it easier to identify and extract the character string.

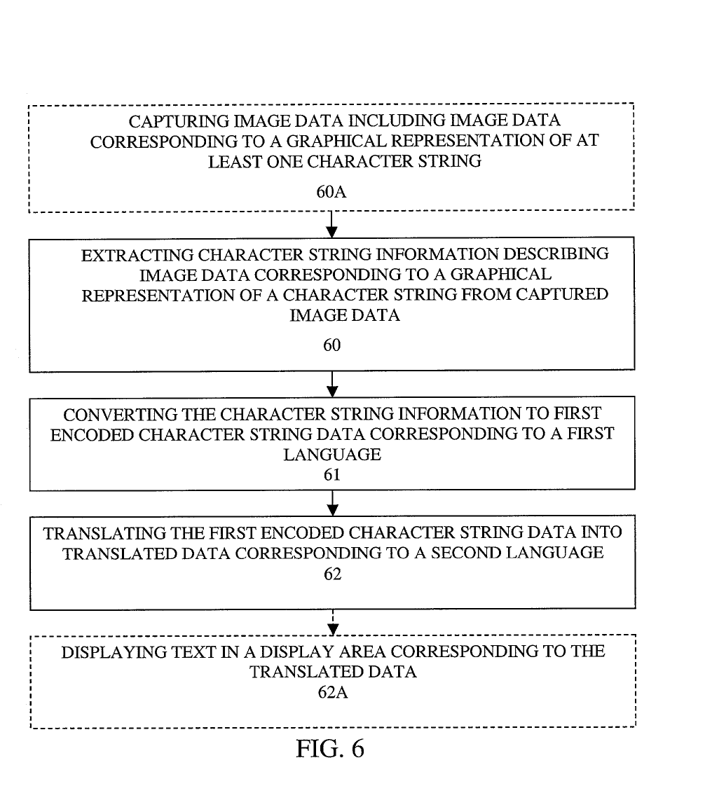

FIG. 6 illustrates a first embodiment of a method of language translation according to the present invention. The method includes optionally capturing (60A) image data that includes image data corresponding to a graphical representation of at least one character string. Alternatively, the image data may already be available. For instance, the captured image data may be transmitted from a remote source to the apparatus 72. In this case the method does not include capturing the image data. Next, character string information describing image data corresponding to the graphical representation of at least one character string is extracted from the captured imaged data (60). The character string information is then converted (61) into first encoded character string data associated with a first language. The first encoded character string data is then translated to generate translated data corresponding to a second language (62). According to this method, text corresponding to the translated data can be optionally displayed (62A).

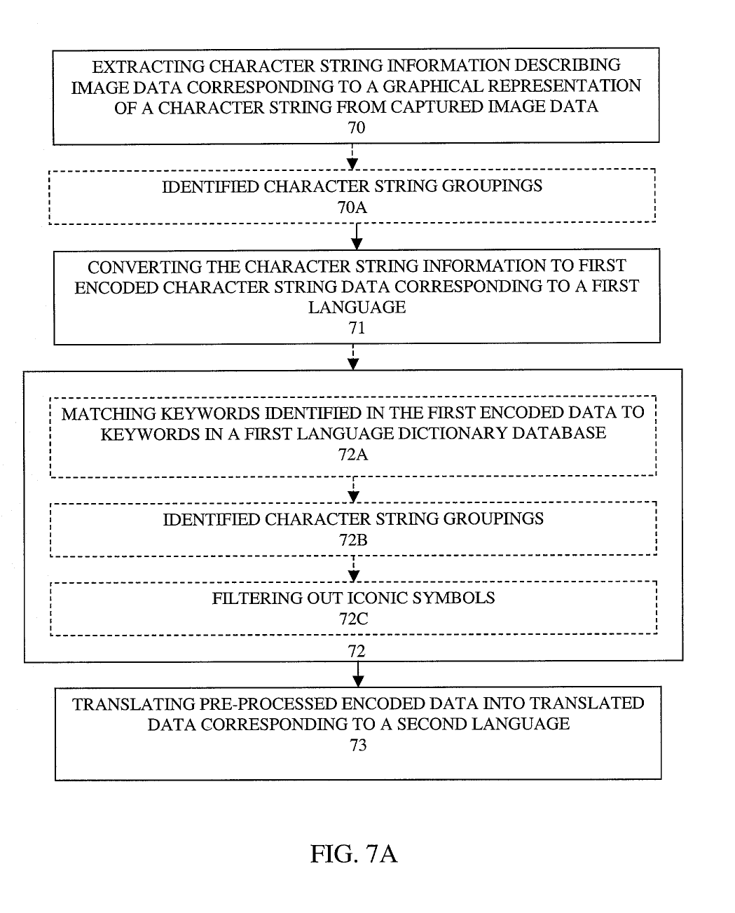

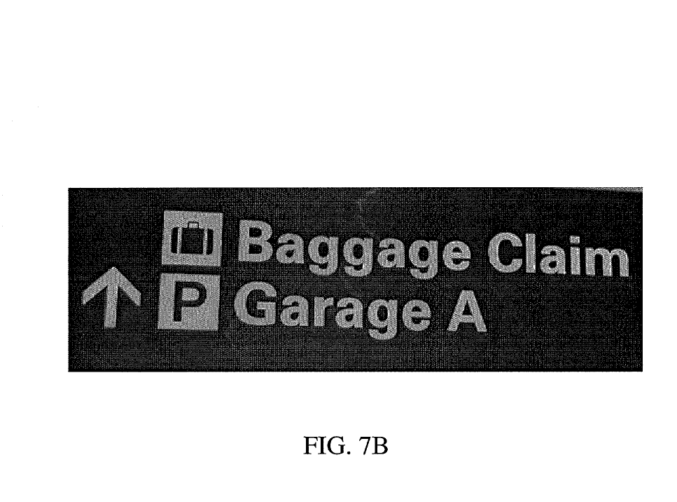

FIG. 7A illustrates a second method according to the present invention. In accordance with this method, character string information describing image data corresponding to a graphical representation of at least one character string is extracted from captured image data (70). In one embodiment, character string groupings can optionally be identified (70A) from the character string information. Identifying character string groups can provide information regarding words or phrases in the character string and can optimize subsequent processing during the translation. The character string information (along with the character string grouping information) can be used to convert (71) the character string information to first encoded character string data corresponding to a first language. Alternatively, if character string groupings are not identified, then the character string information is converted to first encoded character string data without grouping information. Next, the first encoded character string data is pre-processed (72) to put into condition for translation. Preprocessing can include at least one of matching keywords (72A), determining character string groupings (72B) (if groupings had not previously been identified), and filtering out possible iconic symbols (72C).

Keyword matching (72A) allows grouped sets of first encoded characters to be matched to a corresponding word or phrase database. This pre-processing may also be performed while translating, however up-front matching can reduces the amount of processing time required when translating. As described above, groups of characters can also be identified at this point (72B) if it is not performed prior to converting the character string information. Filtering out of iconic symbols (72C) is desirable since iconic symbols are often mistakenly identified as characters since they are graphically represented by simple line figures. For instance, referring to FIG. 7B, the arrow symbol or the baggage symbol may be mistakenly identified as characters since each are graphically composed of simple curves and lines similar to that of the adjacent characters “Baggage claim” and “Garage A”. As a result, when extracting the character string information (70), an iconic symbol adjacent to the character string can be included in the character string information although it is not a character in the string. Moreover, when the character string information is converted into first encoded character string data, the iconic symbol may also be converted as an erroneous character because the conversion software (e.g., the OCR software) often provides a default or “best guess” encoding for characters that can not be clearly identified. Consequently, to increase translation accuracy, it is desirable to filter out the erroneous encoded character data corresponding to the iconic symbols prior to translating (73). Finally, the pre-processed encoded data is translated to generate translated (73) data corresponding to a second language. As described in the previous embodiment of the method, the text corresponding to the translated data can then be optionally displayed.

In one embodiment, the method of filtering out iconic symbols includes converting the character string information into encoded character string data according to the methods shown in FIGS. 6 and 7A and then using a dictionary database to match words identified in the character string to words in the database. A score is derived dependent on the number of exactly matched words. Then a “suspected” encoded character is removed and a new score is determined for the same string. If the score increases by a predetermined amount, it is assumed that that the “suspected” character that was removed corresponds to an erroneously converted iconic symbol. If not, a new character is removed and the process is iteratively repeated.

In another embodiment, the method of filtering out iconic symbols is based on the fact that typically no two optical character recognition algorithms handles unrecognizable characters in the same manner. For instance, one may assign non-recognizable characters to a default symbol (e.g., a pound sign or a square) whereas another may represent it with an actual “best guess” character. Hence, according to this method, the character string is converted into encoded character string data using two different OCR or conversion algorithms. It is assumed that characters that convert the same using the two different conversion algorithms are correctly converted (non-iconic symbol) characters and that characters that do not convert the same using the two conversion algorithms correspond to iconic characters.

Hence, a system and method allowing translation of signs posted in the natural environment is described.

In the preceding description, numerous specific details are set forth in order to provide a thorough understanding of the present invention. It will be apparent, however, to one skilled in the art that these specific details need not be employed to practice the present invention. In addition, it is to be understood that the particular embodiments shown and described by way of illustration is in no way intended to be considered limiting. Reference to the details of these embodiments is not intended to limit the scope of the claims.

We claim:

1. A system of language translation comprising:
character image extractor (30) for extracting character string information describing image data corresponding to a graphical representation of at least one character string from captured image data;
character recognizer (31) for converting character string information into first encoded character string data corresponding to a first language;
language translator (32) for converting the first encoded character string data into translated data corresponding to a second language.

2. The system as described in claim 1 further comprising an image capture portion for capturing image data including the graphical representation of the character string and providing corresponding captured image data.

3. The system as described in claim 1 further comprising a display portion for displaying text corresponding to the translated data.

4. The system as described in claim 1 wherein the character image extractor is implemented within a mobile device including at least an image capture portion for capturing image data including the graphical representation of the character string and providing corresponding captured image data and a display portion for displaying text corresponding to the translated data.

5. The system as described in claim 1 wherein the character image extractor resides at a client location and the character recognizer resides at a server location.

6. The system as described in claim 1 wherein the character image extractor resides at a client location wherein the language translator resides at a server location.

7. A method of language translation comprising:
extracting (40) character string information describing image data corresponding to a graphical representation of a character string from captured image data;
converting (41) character string information corresponding to the extracted image data to first encoded character string data corresponding to a first language;
translating (42) the first encoded character string data into translated data corresponding to a second language.

8. The method as described in claim 7 further comprising capturing image data including a graphical representation of at least one character string.

9. The method as described in claim 7 further comprising displaying text corresponding to the translated data.

10. The method as described in claim 7 comprising extracting character string information at a client location.

11. The method as described in claim 7 comprising converting the character string information to first encoded character string data corresponding to a first language at a server location.

12. The method as described in claim 7 comprising translating the first encoded character string data into translated data corresponding to a second language at a server location.

13. The method as described in claim 7 comprising identifying within the encoded character string data groupings of characters prior to translating the first encoded character string data into the translated data.

14. The method as described in claim 7 comprising identifying within the character string information data groupings of characters prior to converting the character string information to the first encoded character string data.

15. The method as described in claim 9 comprising displaying multiple versions of the translated data thereby providing a list of possible translations of the character string.

16. The method as described in claim 9 comprising displaying the translated data and the captured image by overlaying the translated data upon the captured image.

17. The method as described in claim 9 comprising displaying the translated data and the captured image wherein the translated data is displayed adjacent to the corresponding graphical representation of the character string in the captured image.

18. The method as described in claim 9 comprising displaying the translated data and the captured image wherein the translated data is displayed on top of the corresponding graphical representation of the character string in the captured image.

19. The method as described in claim 7 further comprising filtering out (72B) iconic symbols from the first encoded character string data by comparing multiple versions of optical character recognition (OCR) results.

20. The method as described in claim 7 further comprising matching (72A) groups of characters identified in the first encoded data to keywords in a first language dictionary database.
